(19) United States
(12) Patent Application Publication
(10) Pub. No.: US 2005/0020462 A1
(43) Pub. Date: Jan. 27, 2005

(54) System and method for removing coatings from plastic parts

(76) Inventors: Mark Sanders, Zionsville, IN (US); Rick A. Gates, Winchester, IN (US); Jerald C. Shipley, Winchester, IN (US)

Correspondence Address: MAGINOT, MOORE & BECK;BANK ONE CENTER/TOWER, 1111 MONUMENT CIRCLE, INDIANAPOLIS, IN, 46204, US

(21) Appl. No.: 10/624,824

(22) Filed: Jul. 22, 2003

(51) Int. Cl. C11D 1/00

(52) U.S. Cl. 510/175

(57) ABSTRACT

The process for removing paint from a part comprises the steps of immersing the part in a chemical bath containing a chemical solution effective to strip the paint from the part, and directing an aerated jet spray of the chemical solution onto the part immersed in the chemical bath. The chemical solution is recirculated through the bath and through a filter and heater. The process permits the use of low toxicity chemical solutions, such as sodium hydroxide. The system includes a tank defining a dip chamber with a fluid recirculation path connected outside said tank to recirculate the chemical through the chemical bath. A plurality of spray nozzles are supported within the tank, and are oriented to direct a jet spray of the chemical solution through the chemical bath and onto the process part in a manner effective to strip the coating from the part.

### BACKGROUND OF THE INVENTION

The present invention concerns systems and methods for removing coatings from parts, and particularly from polymeric surfaces. The invention more specifically concerns systems and methods for removing paint from painted plastic parts.

There are many groups of products and associated processes in which polymeric materials, such as plastics, are coated with a material, such as paint. One such product group is automobile components, such as bumpers, grills and other plastic parts used in an automobile. As vehicle weight became an increasing concern, the automotive industry turned to plastic to help reduce overall vehicle weight. As part of this revolution, the traditional metal components were replaced with plastic equivalents for substantial weight reductions. The plastic bumper not only provides significant weight reduction, it does so with acceptable crash-worthiness, and even exhibits resilience during low-speed collisions. Another benefit of plastic components is the ability to paint the components to match the vehicle. While many metal components, such as bumpers or grills, had been chromed in the past, the chrome tended to flake off after only a few years. Plastic components readily accept the paints used to color the component so that a painted plastic component can hold its color for almost the entire useful life of the product

While the affinity between polymeric surfaces and paint makes for a long-lasting painted part, this same characteristic poses problems for rejected parts. In some instances, a manufactured plastic part may be rejected after inspection for a number of reasons. For instance, a part is rejected when dirt or dust becomes embedded in the paint coating, or when the paint is not uniform across the entire part. By some estimates, reject rates can exceed 15% of the total part production for a typical plastic automotive component manufacturing process. This scrap rate amounts to over three million pounds of rejected painted plastic parts every year, which represents enough plastic to leave the entire state of Indiana almost 2½ inches deep in plastic waste.

In accordance with most state environmental regulations, painted plastic parts constitute hazardous waste if sent to a landfill. Some manufacturers do send their scrap painted plastic parts to landfills, and some plastics are even disposed of illegally in spite of the best environmental enforcement efforts. Obviously, the great volume of scrap plastic parts represents an environmental and landfill crisis.

In order to alleviate this crisis, many companies have attempted to recycle or reclaim painted plastic parts. In the recycling approach, the entire plastic part is reduced to pellets that are sold as feedstock to plastics molding companies. The critical technology with this approach entails separating the plastic from the paint, as described in U.S. Pat. No. 6,474,574. Of course, with this approach, the component is destroyed and loses substantial value when it is reduced to palletized feedstock.

In the reclamation approach, the purpose is to preserve the molded plastic component, such as a grill or bumper, and only remove the layer of paint. In one type of reclamation process, a painted bumper is subjected to high pressure jets of water and/or pre-heated air, as described in U.S. Pat. No. 6,258,178. One significant problem with this process is that the high velocity and high pressure water jets can pit or damage the surface of the bumper. Surface roughness is a critical parameter to producing a uniform painted surface. The use of the high velocity water jet can yield a surface roughness that renders the processed part unacceptable for painting. This second rejection leads to recycling of the bumper plastic material.

In another reclamation approach, highly toxic chemicals are used to dissolve and strip the paint from the painted plastic part. One drawback of this approach is that it typically uses methylene chloride, which is highly regulated by the federal Environmental Protection Agency and by state environmental agencies. The chemical itself is a hazardous waste that requires significant accommodations for safe handling and significant expense for safe disposal.

One other reclamation process involves running the scrap parts through a burn off oven. The oven temperatures are sufficiently high to burn the paint or other coating off the subject part without melting the part itself. This burning process leaves a potash residue that is also a hazardous waste. Moreover, the burning process creates defects in a certain percentage of the plastic parts sought to be reclaimed.

All of the above processes can be cost-prohibitive, especially for smaller producers of plastic parts, and most especially if the reclamation rates are not very high. There is a critical need for a system and process that can remove paint from plastic parts in a rapid, efficient and economic manner.

### SUMMARY OF THE INVENTION

In view of the foregoing substantial need, the present invention provides a system and method for effectively removing a layer of paint from a painted component, such as a polymeric or plastic part. In one aspect of the invention, a process is provided for removing a coating from a part that comprises the steps of immersing the part in a chemical bath contained within a process tank, the bath containing a first chemical solution effective to strip the coating from the part. While the part is immersed, the method calls for directing an aerated jet spray of a second chemical solution onto the part, the second chemical solution effective to strip the coating from the part. In the preferred embodiment, the first and second chemical solutions are the same chemical solution, which can be sodium hydroxide in a specific embodiment. The present invention permits the use of much less toxic chemical solutions than prior art techniques for stripping paint from plastic parts.

In a further feature of the inventive method, the chemical solution is heated above room temperature. In one embodiment, the solution is heated by flowing the solution through the chemical bath and through a recirculation path. A heater is interposed within the recirculation path and is controlled to maintain an effective temperature for the chemical solution. The recirculation path also preferably includes a filter for filtering material stripped from the process part.

In another aspect of the invention, the aerated jet spray of the chemical solution is directed in a direction transverse to the direction of recirculation of the solution through the chemical bath. Preferably, a plurality of spray nozzles are directed onto the process part from opposite sides of the process tank.

The invention also contemplates a system for removing a coating from a part, such as paint from a plastic part. The system comprises a tank having opposite side walls, opposite front and back walls between said side walls, a bottom wall and an open top with a lid adapted to close the open top. The tank defines a dip chamber configured to contain the chemical bath and sized to receive at least the part immersed within the chemical bath. Preferably, the tank is sized to receive a plurality of such parts carried by a rack that is immersed in the bath through the open top.

In one aspect of the invention, the tank defines an inlet and an outlet at the opposite side walls of the tank. A fluid recirculation path is connected outside the tank between the outlet and the inlet and includes a pump for flowing the chemical solution through the chemical bath within the dip chamber. The recirculation path preferably includes a filter adapted to filter debris and materials removed from the process part. In addition, a heater is preferably interposed within the recirculation path to maintain the chemical solution and chemical bath at a predetermined temperature effective to enhance the ability of the chemical solution to strip the coating form the process part.

The tank further includes a plurality of spray nozzles supported on at least one of said front wall and said back wall of the tank, and most preferably on both walls. The spray nozzles are fluidly connectable to a source of the chemical solution. In one embodiment of the invention, the tank includes an outer tank and an inner tank nested within the outer tank and defining an interior cavity between the outer tank and the inner tank. The interior cavity includes insulation disposed between the inner tank and the outer tank. The tank includes a plumbing assembly disposed within the interior cavity, the plumbing assembly including the plurality of spray nozzles and at least one fluid inlet connectable to the source of the chemical solution.

The inventive system further includes an inlet tube in fluid communication with the plurality of spray nozzles, and including a fluid inlet connectable to the source of a chemical solution. An agitation pump is preferably provided to draw chemical solution from the source at a predetermined pressure and flow rate that is calibrated so that the spray jets can effectively strip the coating from the process part. In addition, a source of pressurized air connected to the inlet tube to aerate the chemical solution flowing into the inlet tube through the fluid inlet. A valve controls the pressure and flow rate of the pressurized air to optimize the size and quantity of air bubbles entrained within the jet spray of the chemical solution.

In an alternative embodiment of the system, a process tank is provided having opposite side walls, opposite front and back walls between the side walls, a bottom wall and an open top with a lid adapted to close the open top. The tank defines a dip chamber configured to contain a chemical bath and sized to receive at least the part immersed within the chemical bath. The tank further defines an inlet and an outlet at the opposite side walls of the tank, with a fluid recirculation path connected outside the tank between the outlet and the inlet and including a pump for flowing a chemical solution through the dip chamber. In one feature of this alternative embodiment, a plurality of impellers are mounted on the tank within the dip chamber, the impellers operable to generate a vortex in a chemical bath disposed within the dip chamber when a part is immersed therein. Preferably, the impellers are mounted on the underside of the lid so that the impellers are immersed within the chemical bath when the lid is closed over the tank.

The invention further contemplates a method for removing paint from the surface a plastic part comprising the steps of immersing the plastic part in a bath of a chemical solution adapted to remove paint from the surface of the plastic part, flowing the chemical solution in a first direction across the plastic part at a first flow rate, and impinging the plastic part with an aerated jet of the chemical solution in a second direction different from the first direction and at a second flow rate greater than the first flow rate.

One object of the present invention is to provide a system and method for removing a coating from a component that is efficient and that does not require the use of toxic or environmentally regulated chemical solutions. A more specific object is to provide such a system and method that can effectively remove a paint coating from the surface of a plastic part.

A broader objective is to reduce the amount of waste plastic parts that are created when a paint coating is deemed unacceptable. One benefit of the present invention is that the defective plastic part need not be scrapped or recycled by destroying the part. Instead, the present invention allows the part to be, in effect, refurbished by removing the improper paint coating. Since the part itself is intact, it can be reused.

Another significant benefit of the invention is that the improperly coated part can be refurbished without the use of chemical solutions that are themselves regarded as hazardous by environmental regulatory agencies. With the present invention, much less toxic chemical solutions can be used that pose significantly less troublesome disposal problems than with prior paint removal techniques.

Other objects and benefits of the invention will become apparent upon consideration of the following written description taken together with the accompanying figures.

### BRIEF DESCRIPTION OF THE DRAWINGS

FIG. 1 is a top perspective view of a process tank in accordance with one embodiment of the present invention.

FIG. 2 is a side cut-away view of the process tank shown in FIG. 1.

FIG. 3 is a bottom perspective view of a plumbing assembly incorporated within the process tank shown in FIGS. 1 and 2.

FIG. 4 is a front view of the plumbing assembly shown in FIG. 3.

FIG. 5 is a front view of the inner tank back wall incorporated within the process tank shown in FIGS. 1 and 2.

FIG. 6 is a back view of the inner tank front wall of the process tank shown in FIGS. 1 and 2.

FIG. 7 is a side view of the inner tank side wall for the process tank shown in FIGS. 1 and 2.

FIG. 8 is a front view of the outer tank back wall included in the process tank shown in FIGS. 1 and 2.

FIG. 9 is an exploded side view a back wall support and a portion of the plumbing assembly mounted within the process tank shown in FIGS. 1 and 2.

FIG. 10 is a schematic representation of the nozzle system incorporated within the process tank shown in FIGS. 1 and 2.

FIG. 11 is a schematic representation of the process chemical flow circuit used with the process tank shown in FIG. 1.

FIG. 12 is a plan view of a process facility incorporating the process tank shown in FIG. 1.

FIG. 13 is a front perspective view of a process tank in an alternative embodiment of the present invention.

### DESCRIPTION OF THE PREFERRED EMBODIMENTS

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

The present invention contemplates a system and process for removing coatings, such as paint, from painted parts, and most particularly painted plastic parts. The invention contemplates dipping the parts to be treated in a chemical bath in which the chemical solution is heated and filtered and flows across the parts at a controllable rate. In addition, the invention contemplates impinging the coating with an aerated jet of the chemical solution. The flow rate and pressure of the aerated jet of chemical solution can be calibrated to the particular coating to be removed and the characteristics of the underlying plastic material.

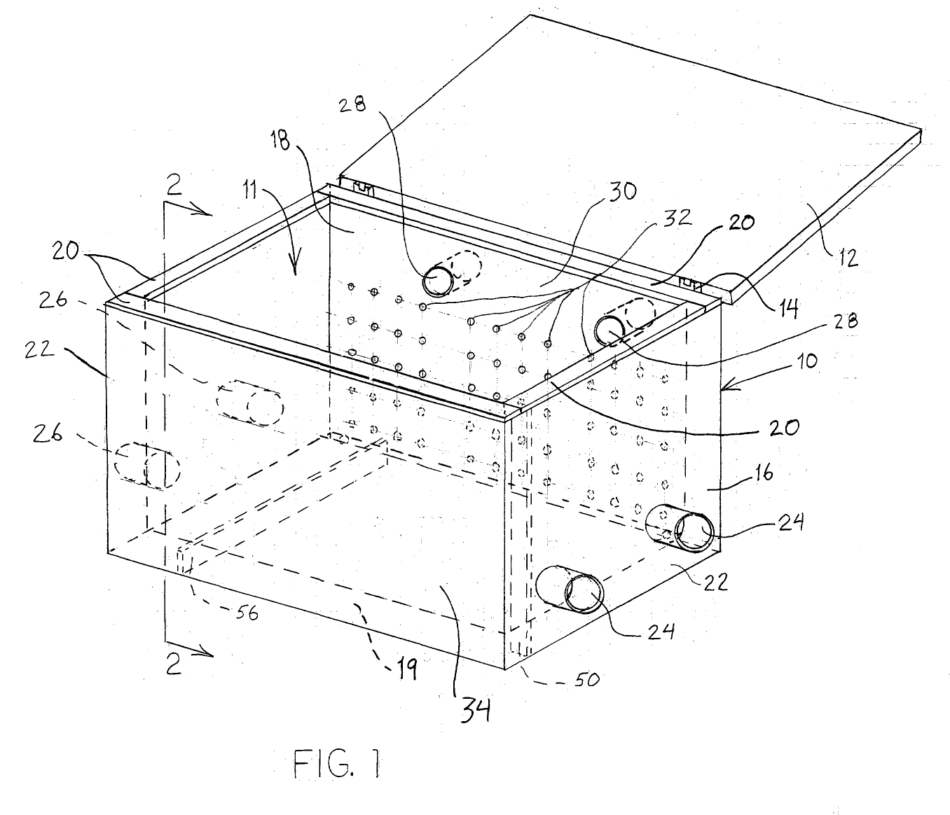

In a preferred embodiment of the invention, a process tank 10 can be provided as shown in FIG. 1. The process tank defines a dip chamber 11 that is enclosed by a lid 12 mounted by hinges 14 so that the lid forms a tight seal with the body of the tank. The process tank 10, and specifically the chamber 11, is preferably sized to contain plastic parts carried on a submersible rack. In a specific embodiment, the process tank is configured to receive one or more painted plastic automobile components carried by a metal dip rack conveyed overhead. In a specific embodiment, the process tank can have a width of about 52 inches, a length of about 100 inches and a height of 60 inches to accommodate a dip rack carrying twenty average sized plastic automobile grills.

In the preferred embodiment, the process tank 10 is formed by an outer tank 16 and a nested inner tank 14. All of the walls of the two tanks are offset from each other to provide an interior cavity 19. The perimeter around the top of the two tanks 16, 18 is sealed by seal plates 20 to close the cavity 19. The seal plates 20 also provide a fluid-tight sealing surface against which the lid 12 engages when the process tank 10 is in use. As described in more detail below, supports are provided between the outer tank and inner tank to support the inner tank within the outer tank and to maintain the interior cavity 19. In the preferred embodiment, this space is filled with an insulating material (not shown) to help maintain an optimum temperature range within the dip chamber 11. The insulation can be a high temperature fiberboard. In a specific embodiment, the outer tank 16 and inner tank 18 are sized relative to each other to maintain a spacing of about 3.5 inches for the interior cavity.

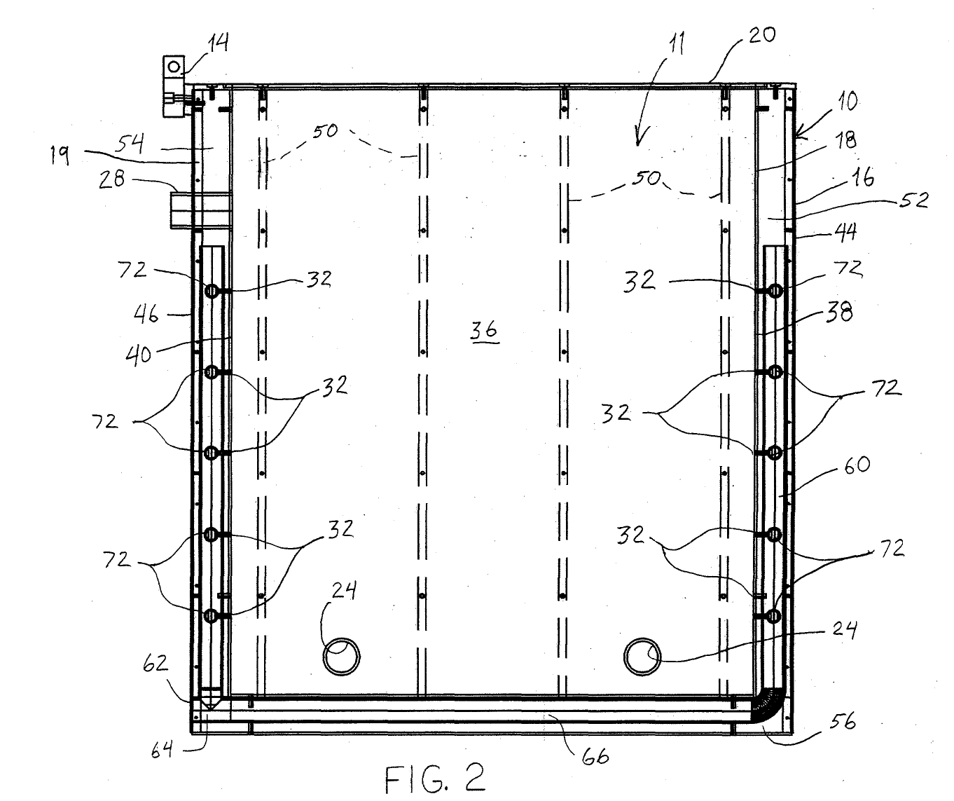

The process tank 10 is provided with end walls 22. The end walls are configured to support inlet tubes 24 and outlet tubes 26 at opposite ends of the tank, as shown in FIGS. 1 and 2. It should be understood that the outer tank and the inner tank both include an end wall, with the two walls being similarly configured to support the particular inlet or outlet tube 24 or 26. The tank further includes a back wall 30 that supports a number of vent tubes 28. As will be described in more detail herein, the inlet and outlet tubes 24, 26 provide a flow path for process chemicals to flow through the chamber 11 and across the parts being treated. This internal flow is necessary to wash away coating materials stripped from the surface of the process part. The vent tubes 28 vent any gas generated during the process and accounts for any overflow of the process chemicals within the tank 10.

The back wall 30 also supports a plurality of nozzles 32. The nozzles are connected to a source of air and a source of process chemical and are configured to produce a high pressure, high velocity aerated jet impinging on the painted surface of the part being processed. The front wall 34 is also provided with a similar array of nozzles 32. In the illustrated embodiment, 120 nozzles are provided at 6 inch horizontal and 8 inch vertical intervals to maximize exposure of the processed parts to the effects of the aerated chemical jetting from the nozzles. The nozzles 32 can have a variety of configurations to produce a number of different spray patterns, such as flat, cone, spiral, rotating or hollow. The nozzles are preferably configured to keep air bubbles entrained within the liquid chemical jet until the jet strikes the process part. In addition, the nozzles are preferably configured to provide a spray pattern that can be maintained when the jet is passing through the liquid chemicals flowing transversely to the spray path.

Referring now to FIG. 2, the interior features of the process tank 10 can be seen. The inner tank 18 includes a side wall 36, a front wall 38 and a back wall 40. The outer tank 16 includes similarly configured side walls (not seen), a front wall 44 and a back wall 46. The interior cavity 19 is maintained between the outer and inner tank walls by a number of supports. For instance, side wall supports 50 are disposed between the inner tank side wall 36 and the outer tank side wall. Likewise, front wall supports 52 and back wall supports 54 separate the corresponding front and back walls 38, 44 and 40, 46. The inner tank is supported above or offset from the base of the outer tank by a number of bottom wall supports 56 (see also FIG. 1). The number and thickness of the supports 50, 52, 54 and 56 are calibrated to support the weight of the process chemicals contained within the dip chamber 11, as well as the weight of the inner tank. In a specific embodiment, the supports are spaced 14-16 inches apart, so that four supports are provided in the sides of the tank and seven supports are situated at the bottom, front and back walls. The supports are preferably 0.75 inch thick stainless steel panels.

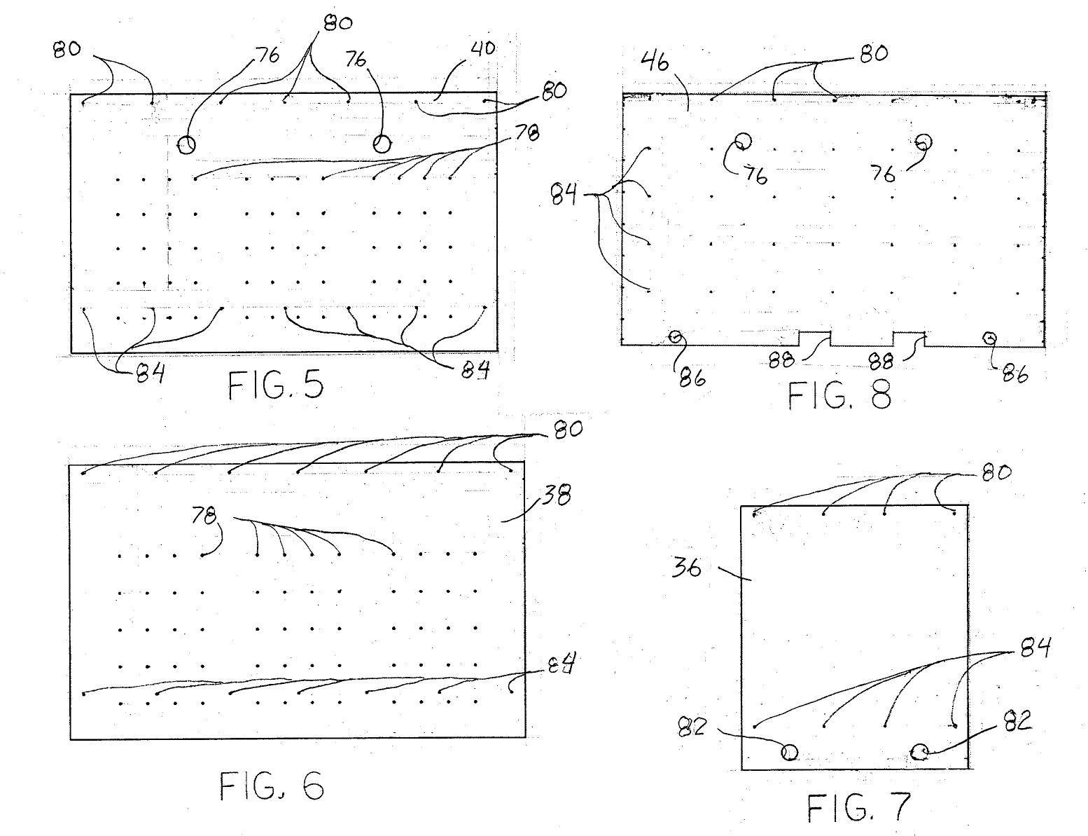

Details of the walls of the tanks can be seen in FIGS. 5-8. As shown in FIG. 5, the back wall 40 of the inner tank includes a pair of openings 76 for receiving and supporting the vent tubes 76. The openings and vent tubes can be welded or screwed together. The back wall also defines a plurality of nozzle openings 78 through which the nozzles 32 extend. Screw holes 80 near the upper edge of the back wall 40 and screw holes 84 near the bottom edge provide means for engaging the supports. The front wall 38 shown in FIG. 6 is similar in construction to the back wall 40, except that the vent tube openings are not necessary. The front wall 38 also includes a like plurality of nozzle openings 78 to receive the spray nozzles 32.

Turning to FIG. 7, an exemplary side wall 36 is shown. The side wall includes screw holes 80, 84 for mounting the side wall supports 50. The side wall 38 also defines openings 82 for the inlet or outlet tubes 24 or 26 depending on which side of the tank the walls are located. The side walls of the outer tank are configured similar to the side wall 36 shown in FIG. 7, with additional height and width.

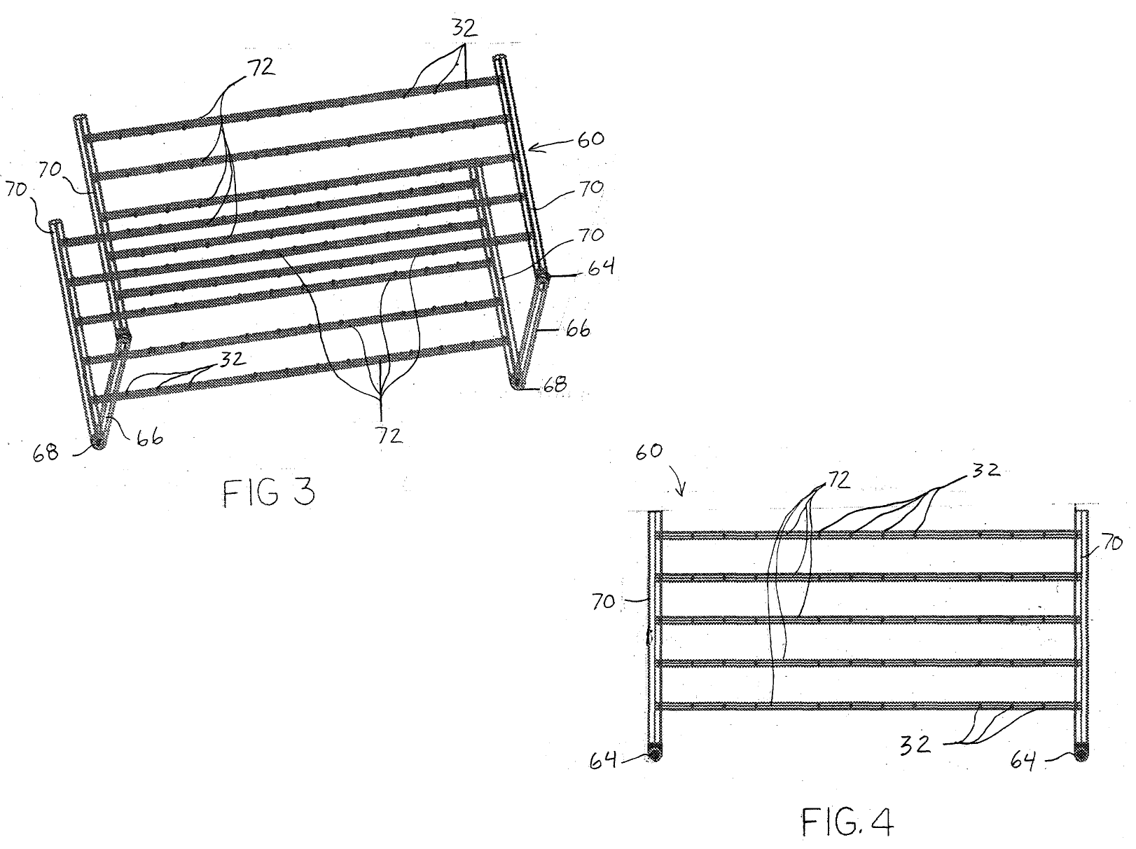

The back wall 46 of the outer tank 16 is shown in FIG. 8. The outer tank does not include any openings for the spray nozzles, since the nozzles are directed to the interior dip chamber 11. Instead, the outer tank defines screw bores 84 for mounting the back wall supports 54. In addition, the outer tank back wall 46 defines a pair of openings 76 for the vent tubes, like the back wall 40 of the inner tank 18. However, unlike the inner tank back wall, the outer tank back wall 46 defines a second pair of openings 86 near the bottom of the wall. These openings accommodate inlets of the plumbing assembly 60 shown in FIGS. 3-4. In addition, the back wall 46 defines a pair of lift slots 88 at the bottom edge of the wall. These slots 88 permit forklift access to lift the entire process tank 10 when it is necessary to move the tank.

Turning back to FIGS. 3-4, details of the plumbing assembly 60 are shown. As can be appreciated from FIG. 2, the plumbing assembly resides within the interior cavity 19. The perspective view of the assembly 60 shown in FIG. 3 thus depicts the portion of the assembly that is situated within that cavity. The assembly includes a pair of tees 64 that define inlets 62 that are situated at the openings 86 in the back wall 46 of the outer tank 16. One branch of the tees 64 each communicate with a corresponding transfer pipe 66 that runs along the bottom of the tank 10, as shown in FIG. 2. The transfer pipes 66 are each connected to an elbow 68. The other branch of the tees 64 communicate with vertically oriented tower pipes 70 situated at the back wall 30 of the tank. Likewise, the elbows 68 communicate with respective tower pipes 70 oriented at the front wall 34 of the tank 10.

Disposed horizontally between corresponding tower pipes are a plurality of division pipes 72. In the preferred embodiment, five such division pipes 72 are provided at both the front and the back walls of the tank, as shown in FIGS. 2-4. The nozzles 32 are connected to the division pipes to provide a spray exit for fluid traveling from the inlets 62, through the tees 64, transfer pipes 66 and elbows 68, and up the tower pipes 70 to the division pipes 72. As shown in FIG. 2, the tower pipes 70 are capped at a height below the vent tubes 28. This arrangement accommodates chemical levels within the tank 10 that are just below the vent tubes 28, while providing sufficient jet spray coverage for plastic components immersed in the chemical bath within the dip chamber 11.

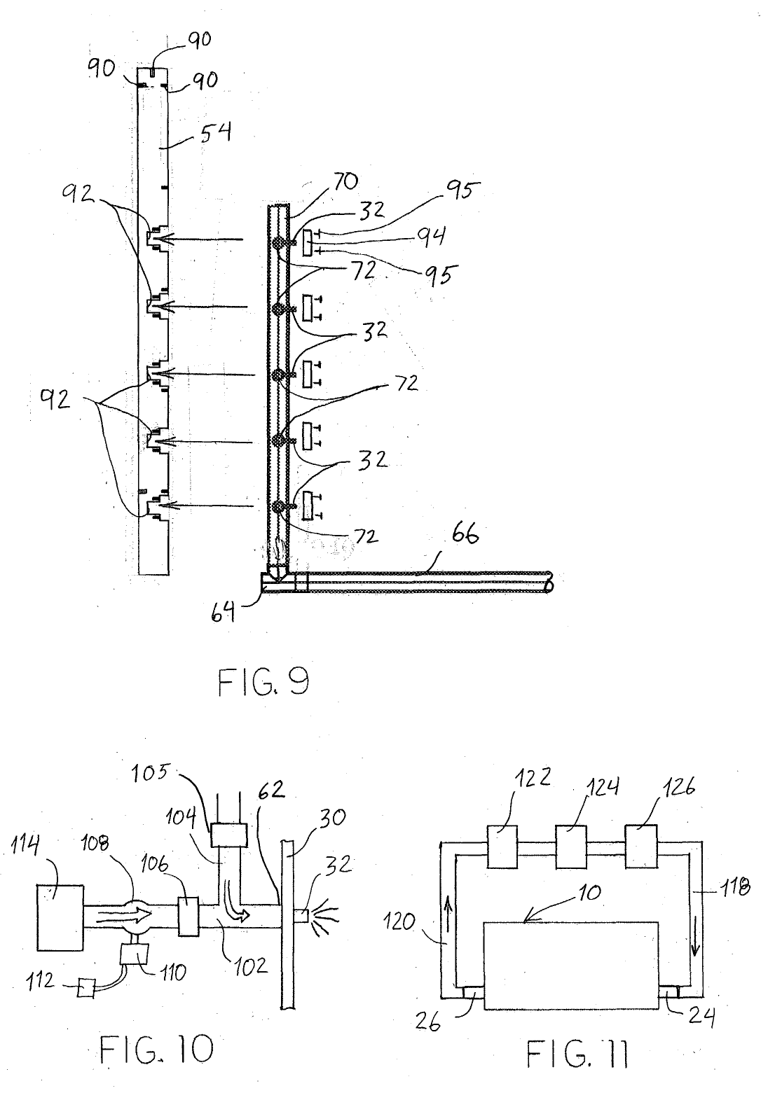

The division pipes 72 are supported within the interior cavity 19 by the front and back wall supports 52, 54, respectively. An exemplary back wall support 54 is shown in FIG. 9, with the understanding that the front wall supports 52 are similarly configured, although facing in the opposite direction to the back wall supports 54. As shown in FIG. 9, the support 54 defines a number of notches 92 that are sized to snugly receive a corresponding division pipe 72. A clamping block 94 is provided for each notch 92 and can be fastened to the support 54 by a pair of screws 95. The clamping blocks 94 trap each division pipe within its corresponding notch 92 in the support.

Additional features of the plumbing system 60 are shown in FIG. 10, and particularly the components of the system that are exterior to the process tank 10. A pressurized inlet tube 102 communicates with each inlet 62 of the plumbing system 60. A nozzle 32 is schematically depicted as mounted within back wall 30. Although this schematic representation suggests that the inlet tube 102 communicates directly with the nozzle 32, it should be understood that the pressurized fluid is actually conveyed through the tower pipes 70 and division pipes 72 to each nozzle 32.

The inlet tube 102 is fed chemical solution through the fluid inlet 104. The solution can be pumped by an agitation pump 105 from a storage tank (not shown) at a flow rate that is calibrated to achieve an optimum jet spray for the plastic parts within the dip chamber 11. A check valve 106 provides access for compressed air to be injected into the inlet tube 102. A compressed air source 114 feeds through a valve 108. Flow through the valve 108 is adjusted by a controller 110 in response to a signal from a control signal generator 112. In the preferred embodiment, the valve 108 is a solenoid valve, the controller 110 is a solenoid and the signal generator is a relay 112. In one specific embodiment, the relay 112 is an on/off relay so that the solenoid 110 either opens or closes the valve 108. Alternatively, the valve can be a variable flow valve to modulate the pressure and flow rate of the air provided by the source 114. As with the chemical solution, the flow characteristics of the compressed air can be adjusted depending upon the nature of the part and the coating being processed.

In the preferred embodiment, the chemical solution is provided from the pump 105 to the pressurized inlet tube 102 at a flow rate of between 1 gpm and 500 gpm. This flow rate depends on several factors, including the material of the substrate, the coating to be removed, the temperature of the solution and its chemical make-up. For instance, on softer plastics, a lower flow rate may be preferable to avoid pitting the surface of the part. On the other hand, harder plastics, or plastics that are more elastic, can endure higher flow rates of the chemical jet spray. The proper flow rate for the pressurized chemical jet spray may require a testing phase where a new plastic material is encountered.

The air provided by the supply 114 is pressurized above the pressure of the chemical solution. Otherwise, the air will not be able to sufficiently enter the chemical flow and no air bubbles will be entrained in the chemical jet spray. This pressure can be between 1 psi and 250 psi, again calibrated with respect to the fluid agitation pump pressure. The air flow rate can be between 1 cfm and 100 cfm. The flow rate must also be calibrated to the fluid flow rate. Too little air flow results in too few air bubbles entrained within the jet spray, which unnecessarily lengthens the paint stripping process. Too much air and the fluid/air mixture is saturated with air bubbles. In this case, the air bubbles will combine with each other to form larger bubbles that are essentially incapable of providing the necessary abrasive effect. Other problems associated with incorrect air flow rates include pump cavitation and the release of excess air into the working atmosphere. Again, the air flow rate must be calibrated to the chemical flow rate to produce optimum air bubble size and density for sufficient abrasive action as the entrained bubbles contact the part in process.

As explained above, the chemical solution also flows transversely through the dip chamber 11 from the inlet tubes 24 to the outlet tubes 26. In the preferred embodiment, this flow is between 50 gpm and 500 gpm. The optimum cross-flow rate is largely a function of tank size. One function of this cross-flow is to circulate the solution through a circulation heater to control tank fluid temperature. Another function is to push dislodge coating material and other particles out of the dip chamber 11. The flow rate necessary to achieve both functions is dictated by the size of the tank.

The chemical solution cross flow is maintained by additional external components of the plumbing system 60, as shown in FIG. 11. In particular, the inlets 24 are connected to a circulation inlet tube 118, while the outlets feed to a circulation outlet tube 120. The discharged solution is fed through a filter assembly 122, which can be in the form of a tower filter, which is operable to remove the coating material that has been stripped from the part in process. In the preferred embodiment, the filter assembly 122 is capable of filtering suspended solids down to 10 microns. In addition, the filter assembly can be constructed to periodically filter the re-circulated chemical solution down to 1 micron or less.

The filtered re-circulated chemical solution is pulled by a pump 124, which can be a magnetic drive pump. The pump pushes the chemical solution to a heater 126 that heats or re-heats the chemical solution to an optimum temperature for stripping the coating from the process part. In the preferred embodiment, the operating temperature of the chemical solution can range from 60° F. to 230° F., with the upper temperature range being preferred for most painted coatings.

From the foregoing description, it should clear that the present invention contemplates combining a heated dip tank with a jet spray capability. The chemical solution is adapted to strip the coating from the underlying part, such as by disrupting the affinity of the coating for the part or breaking up any chemical or mechanical adhesion of the coating to the underlying part. The chemical solution can be a solution known in the art for removing paint from plastic parts, such as methylene chloride. However, the dangerous and regulated nature of this chemical makes it less acceptable for use in the present invention. Instead, the features of the present invention permit the use of much less hazardous chemicals. For instance, in certain preferred embodiments, the chemical solution can be a 40% solution of sodium hydroxide, or a 60% solution of glycolic acid. In other applications of the present invention, the chemical solution can include N-methyl pyrrilodone, 2-butoxyethanol, isopropyl alcohol, dibasic esters, or ethyl lactate, as well as other reagents, surfactants and reactants suitable to remove paint from a plastic surface.

The dip chamber 11 of the process tank 10 can be filled through the open top of the tank; however, the most preferred approach is to feed the solution through the fluid inlet 104. While the tank is being filled, the lid 12 is opened and the process tank is de-activated, meaning that the various pumps and heaters are de-energized. The process chemical can be pumped from a separate source through the inlet 104 until the tank is filled. Since the circulation pump 124 is not activated, the fluid level within the tank will increase until the level reaches the vent tubes 28. Preferably, the chemical level is directly observed with the lid 12 open. Once the dip chamber 11 has been filled, the separate source and pump can be disconnected and the fluid inlet 104 can be connected to a process chemical source.

When the tank is full, the circulation pump 124 and heater 126 can then be activated to pre-heat the process chemical solution prior to introduction of the process parts. The spray nozzles 32 do not need to be activated at this time. Once the chemical solution is up to temperature, the components can be de-activated so that the process parts can be immersed within the chemical bath. Preferably, the parts are carried on dip racks, while the dip racks are preferably conveyed and supported by an overhead conveyor or crane. Once the dip racks are lowered into the dip chamber 11, the overhead conveyor is disconnected so that the lid 12 can be closed over the process tank. At this time, the systems are re-activated so that the chemical solution circulates through the inlets 24 and the nozzles 32 spray an aerated jet of chemical solution onto the process parts. The duration of the process depends upon the nature of the coating to be removed and the characteristics of the underlying plastic part. Where the process part is of a high density plastic and the coating is a low tenacity coating, the process may last only a few seconds. In this circumstance, the temperature and flow rate of the re-circulated chemical solution can be at a maximum. In addition, the spray velocity through the nozzles can be at a maximum, since the underlying plastic part can withstand greater impingement forces from the air bubbles within the aerated jet chemical solution. On the other hand, where the part material is a low density plastic and the coating is a particularly tenacious paint, much longer process durations may be necessary, on the order of a number of days. In this circumstance, lower temperatures, flow rates and spray velocities can be required to prevent damage to the underlying plastic part.

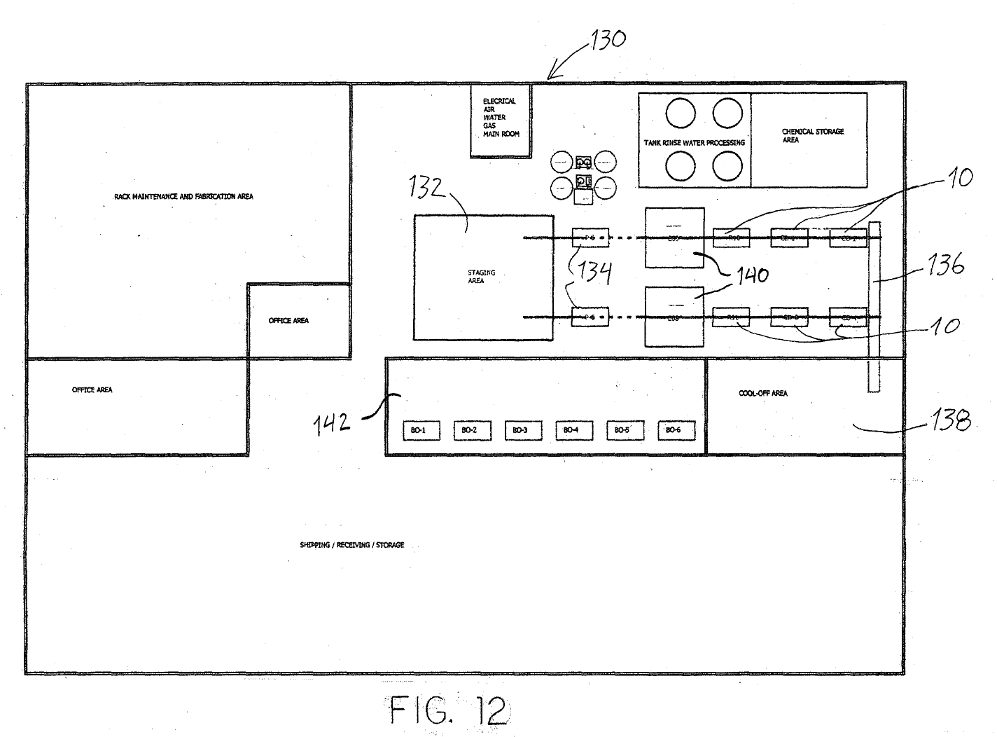

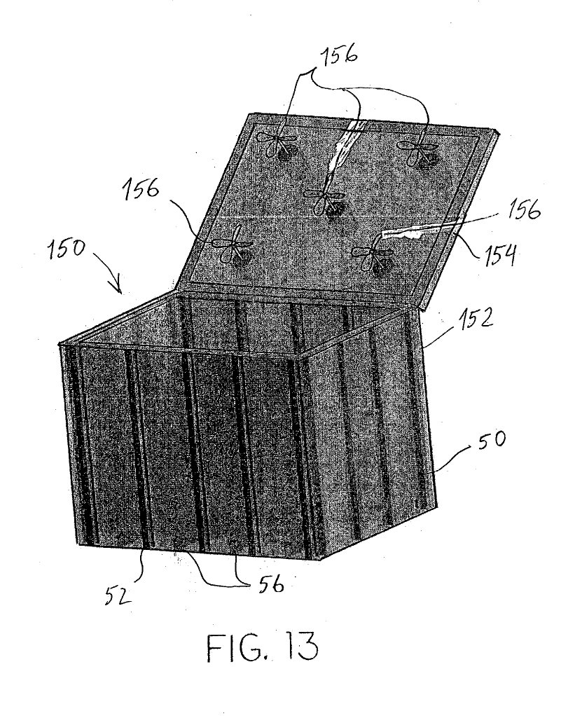

The present invention provides a highly efficient system for stripping coatings from parts that are susceptible to pitting and other defects using traditional stripping processes. In the most preferred use, the parts are plastic, although parts formed of other materials can benefit from the system and method of the present invention. The present system can be implemented in a high volume production facility using a plant layout like that shown in FIG. 12. The facility 130 includes a staging area 132 where the incoming parts are stored in anticipation of processing. The products can be loaded at area 134 onto dip racks that are suspended from an overhead conveyor 136 or that can be engaged and lifted by an overhead crane. A number of process tanks 10 can be provided into which a fully loaded dip rack can be placed. Once the stripping process is completed, the overhead conveyor 136 can re-engage the dip rack to lift the rack from each process tank and transfer the rack to a cool down area 138. Prior to moving to the cool down area, the parts on the dip rack can be carried to a water rinse tank 140 to remove all remaining chemical solution from the parts. It is contemplated that anytime the lid 12 of a dip tank 10 is open, the components of the tank are shut down. In addition, when a dip rack is removed from a tank, it is held suspended above the tank for a period of time sufficient for all the chemical solution to drain off the processed parts. When the parts are cool enough to handle, the racks can be conveyed by the overhead conveyor 136 to an inspection area 142. Parts that fail inspection because some coating remains can be sent back through the process.

The present invention contemplates an alternative process tank, such as the tank 150 shown in FIG. 13. This tank can be similar in construction to the tank 10 of FIG. 1, except that the nozzles 32 have been replaced by agitators 156. In the illustrated embodiment, the agitators are mounted to the underside of the lid 154 and are operable to agitate the process chemicals within the chamber 152. The agitators can be in the form of multi-bladed impellers that are rotated at a high rate to form vortices. The vortices increase the flow rate of the chemical solution impinging the process parts. As an alternative, the impeller blades can include apertures through which air can be fed so that the resulting air bubbles in the vortices provide an abrasive effect similar to the jet spray of the nozzles 32 in the prior embodiment.

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

Preferably, the chemical solution within the dip chamber 11 is the same solution that is injected through the spray nozzles 32. However, in an alternative embodiment, the chemical solution sprayed through the nozzles can be different from the chemical bath within the dip chamber. The difference in chemical solution can be in the form of a different concentration of the same constituent chemicals, or can constitute a different chemical formulation, provided that the different spray formulation does not react adversely with the chemical bath formulation.

As a further alternative, the spray chemical solution can include entrained particles, preferably small micron particles, which can be effective to “shot blast” the coating without damaging the underlying part. For instance, the particles can be micro-sized plastic pellets that can help disrupt the coating when sprayed at sufficient velocity through the chemical bath.

1. A process for removing a coating from a part comprising the steps of:
immersing the part in a chemical bath, the bath containing a first chemical solution effective to strip the coating from the part; and
directing an aerated jet spray of a second chemical solution onto the part immersed in the chemical bath, the second chemical solution effective to strip the coating from the part.

2. The process for removing a coating from a part according to claim 1, wherein said first and second chemical solutions are the same chemical solution.

3. The process for removing a coating from a part according to claim 1, wherein at least one of the first and second chemical solutions includes sodium hydroxide.

4. The process for removing a coating from a part according to claim 1, wherein at least one of the first and second chemical solutions includes a solution selected from the group glycolic acid, N-methyl pyrrilodone, 2-buoxyethanol, isopropyl alcohol, ethyl lactate and dibasic esters.

5. The process for removing a coating from a part according to claim 1, wherein at least said first chemical solution is heated above room temperature.

6. The process for removing a coating from a part according to claim 1, wherein said first chemical solution is continuously recirculated.

7. The process for removing a coating from a part according to claim 6, wherein said first chemical solution is filtered during recirculation.

8. The process for removing a coating from a part according to claim 6, wherein said first chemical solution is recirculated in a direction transverse to the direction of the aerated jet spray of said second chemical solution.

9. The process for removing a coating from a part according to claim 1, wherein said jet spray is provided at a flow rate of between 1 gpm and 500 gpm.

10. The process for removing a coating from a part according to claim 9, wherein said jet spray is produced by combining a flow of said second chemical solution with a flow of pressurized air provided at a pressure between 1 psi and 250 psi.

11. The process for removing a coating from a part according to claim 10, wherein the pressurized air is provided at a flow rate of between 1 cfm and 100 cfm.

12. A system for removing a coating from a part comprising:
a tank having opposite side walls, opposite front and back walls between said side walls, a bottom wall and an open top with a lid adapted to close the open top, said tank defining a dip chamber configured to contain a chemical bath and sized to receive at least the part immersed within the chemical bath;
the tank defining an inlet and an outlet at said opposite side walls of the tank;
a fluid recirculation path connected outside said tank between said outlet and said inlet and including a pump for flowing a chemical solution through said dip chamber; and
a plurality of spray nozzles supported on at least one of said front wall and said back wall of the tank, the spray nozzles fluidly connectable to a source of a chemical solution effective to strip the coating from the part.

13. The system for removing a coating from a part according to claim 12, wherein said tank includes an outer tank and an inner tank nested within said outer tank and defining an interior cavity between said outer tank and said inner tank.

14. The system for removing a coating from a part according to claim 13, wherein said interior cavity includes insulation disposed between said inner tank and said outer tank.

15. The system for removing a coating from a part according to claim 13, further comprising a plumbing assembly disposed within said interior cavity, said plumbing assembly including said plurality of spray nozzles and at least one fluid inlet connectable to the source of the chemical solution.

16. The system for removing a coating from a part according to claim 12, further comprising a plurality of spray nozzles supported on both said front wall and said back wall of the tank.

17. The system for removing a coating from a part according to claim 12, further comprising jet spray means, connectable between said plurality of spray nozzles and the source of a chemical solution, for producing an aerated pressurized flow of the chemical solution to said spray nozzles.

18. The system for removing a coating from a part according to claim 17, wherein said jet spray means includes:
an inlet tube in fluid communication with said plurality of spray nozzles, and including a fluid inlet connectable to the source of a chemical solution;
a source of pressurized air connected to said inlet tube to aerate the chemical solution flowing into said inlet tube through said fluid inlet.

19. The system for removing a coating from a part according to claim 18, wherein said jet spray means includes a valve between said source of pressurized air and said inlet tube, said valve operable in an open position to permit flow of the pressurized air into said inlet tube and in a closed position to prevent flow of the pressurized air into said inlet.

20. The system for removing a coating from a part according to claim 12, wherein said fluid recirculation path includes a heater interposed therein to heat the chemical solution flowing therethrough.

21. A system for removing a coating from a part comprising:
a tank having opposite side walls, opposite front and back walls between said side walls, a bottom wall and an open top with a lid adapted to close the open top, said tank defining a dip chamber configured to contain a chemical bath and sized to receive at least the part immersed within the chemical bath;
the tank defining an inlet and an outlet at said opposite side walls of the tank;
a fluid recirculation path connected outside said tank between said outlet and said inlet and including a pump for flowing a chemical solution through said dip chamber; and
a plurality of impellers mounted on said tank within said dip chamber, said impellers operable to generate a vortex in a chemical bath disposed within the dip chamber when a part is immersed therein.

22. The system for removing a coating according to claim 21, wherein said plurality of impellers are supported on the underside of said lid so that the impellers are immersed in the chemical bath when said lid is closed over said open top.

23. A method for removing paint from the surface a plastic part comprising the steps of:
immersing the plastic part in a bath of a chemical solution adapted to remove paint from the surface of the plastic part;
flowing the chemical solution through the bath across the plastic part at a first flow rate; and
impinging the immersed plastic part with an aerated jet of the chemical solution at a second flow rate greater than the first flow rate.

24. The method for removing paint according to claim 23, further comprising the step of recirculating the chemical solution flowing through the bath.

25. The method for removing paint according to claim 23, wherein the step of recirculating includes recirculating the chemical solution through a filter and a heater.

26. The method for removing paint according to claim 23, wherein the step of impinging includes directing the aerated jet of the chemical solution through a plurality of nozzles oriented to impinge on the part.

27. The method for removing paint according to claim 23, wherein the chemical solution flows through the bath in a first direction and the impinging aerated jet is directed in a second direction different form the first direction.
